(19) United States
(12) Patent Application Publication
(10) Pub. No.: US 2022/0107397 A1
(43) Pub. Date: Apr. 7, 2022

(54) LIDAR SYSTEM

(71) Applicant: KABUSHIKI KAISHA TOSHIBA, Tokyo (JP)

(72) Inventors: Masatoshi HIRONO, Yokohama (JP); Yoichiro KURITA, Minato (JP); Hideto FURUYAMA, Yokohama (JP)

(73) Assignee: KABUSHIKI KAISHA TOSHIBA, Tokyo (JP)

(21) Appl. No.: 17/471,020

(22) Filed: Sep. 9, 2021

(30) Foreign Application Priority Data
Oct. 2, 2020 (JP) 2020-167818

(51) Int. Cl. G01S 7/481; G02B 27/30; G02B 5/04

(52) U.S. Cl. CPC G01S 7/4817; G02B 5/04; G01S 7/4813; G02B 27/30

(57) ABSTRACT

According to one embodiment, a LIDAR system includes a laser oscillator, a collimator lens, a scan device, and a prism. The laser oscillator emits laser light. The collimator lens converts the laser light to parallel light. The scan device includes a reflective surface on which the laser light that has passed through the collimator lens is reflected, and a rotation device rotating the reflective surface around a rotation axis. The prism has a first surface and a second surface, and emits, from the second surface, the laser light that has been reflected on the reflective surface to enter the first surface.

### CROSS-REFERENCE TO RELATED APPLICATIONS

This application is based upon and claims the benefit of priority from Japanese Patent Application No. 2020-167818, filed on Oct. 2, 2020, the entire contents of which are incorporated herein by reference.

### FIELD

Embodiments described herein relate generally to a LIDAR system.

### BACKGROUND

LIDAR systems are used in various technologies such as autonomous driving. The LIDAR system, for example, scans the surface of an object with light in the form of a pulsed. laser to measure the shape of the object and a distance to the object from the amount of time taken for receiving the pulsed laser light reflected by the object.

The LIDAR system uses, for example, a mirror to reflect the laser light to scan the object by changing the mirror orientation. The mirror in the LIDAR system is typically set obliquely relative to the incident direction of the laser light on the mirror. This may, however, cause distortion of the laser scanning range (illumination field).

### BRIEF DESCRIPTION OF THE DRAWINGS

FIG. 1 is an exemplary plan view schematically illustrating a LIDAR system according to a first embodiment;

FIG. 2 is an exemplary side view schematically illustrating an illumination system in the first embodiment;

FIG. 3 is an exemplary plan view schematically illustrating a part of the illumination system in the first embodiment;

FIG. 4 is an exemplary graph schematically illustrating light distribution of laser light in the first embodiment;

FIG. 5 is an exemplary graph schematically illustrating light distribution of laser light in a comparative example;

FIG. 6 is an exemplary side view schematically illustrating an illumination system according to a modification of the first embodiment;

FIG. 7 is an exemplary side view schematically illustrating an illumination system according to a second embodiment; and

FIG. 8 is an exemplary graph schematically illustrating light distribution of laser light in the second embodiment.

### DETAILED DESCRIPTION

According to one embodiment, a LIDAR system. includes a laser oscillator, a collimator lens, a scan device and a prism. The laser oscillator emits laser light. The collimator lens converts the laser light to parallel light. The scan device includes a reflective surface by which the laser light having passed through the collimator lens is reflected, and a rotation device that rotates the reflective surface around a rotation axis. The prism has a first surface and a second surface. The prism allows the laser light reflected by the reflective surface to enter the first surface and exit from the second surface.

### First Embodiment

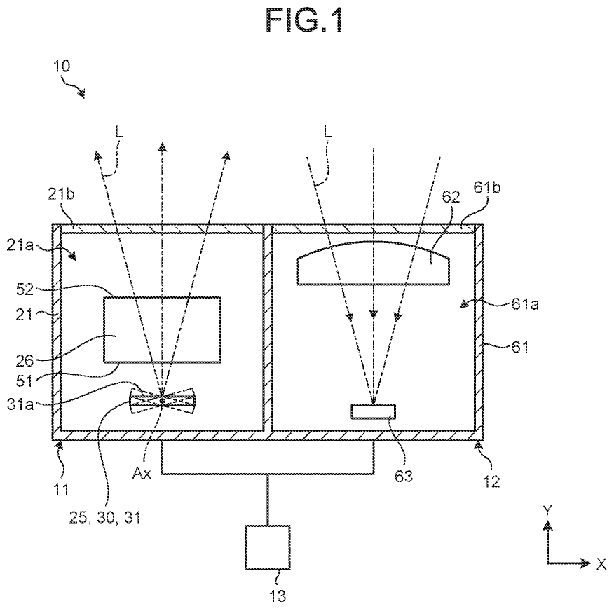

Descriptions of a first embodiment are provided below with reference to FIGS. 1 to 6. Note that, in this specification, constituent elements according to embodiments and descriptions of the constituent elements may be provided in a plurality of expressions. The constituent elements and the explanation thereof are examples and are not limited to the expressions of this specification. The constituent elements can be identified by names different from those in this specification. Further, the constituent elements can also be described by expressions different from those in this specification.

FIG. 1 is an exemplary plan view schematically illustrating a LIDAR system 10 according to the first embodiment. The LIDAR system 10 (light detection and ranging system or laser imaging detection and ranging system) measures the shape of an object and a distance to the object. The LIDAR system 10 is, for example, mounted on an autonomous driving vehicle to measure various objects such as roads, buildings, pedestrians, other cars, and obstacles, although the LIDAR system 10 is not limited to such an example.

As illustrated in each drawing, in this specification, a Cartesian coordinate system is defined for convenience. X, Y and Z-axes are defined as shown in the figures. Also, X, Y and Z-directions are defined as directions as indicated by X, Y and Z-axes.

As illustrated in. FIG. 1, the LIDAR system 10 includes an illumination system 11, a light-receiving system 12, and a control device 13. Note that the LIDAR system 10 may additionally include other devices.

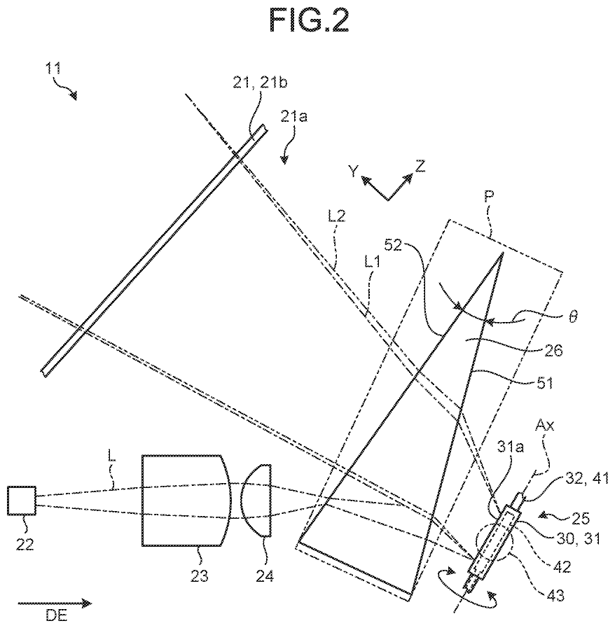

FIG. 2 is an exemplary side view schematically illustrating the illumination system 11 of the first embodiment. As illustrated in FIG. 2, the illumination system 11 includes a casing 21, a laser oscillator 22, a collimator lens 23, a cylindrical lens 24, a scan device 25, and a prism 26. Note that the illumination system 11 is not limited to such an example and may additionally include other parts or components, for example.

The casing 21 accommodates the laser oscillator 22, the collimator lens 23. The cylindrical lens 24, the scan device 25, and the prism 26 in its internal space 21a. The casing 21 has an exit window 21b. The exit window 21b is a member that covers the internal space 21a and allows light to pass through. Note that the exit window 21b is not limited to such an example and may be, for example, a hole that opens the internal space 21a to outside. The exit window 21b faces, for example, the Y-direction.

The laser oscillator 22 is, for example, a laser diode capable of pulsed laser output. The laser oscillator 22 oscillates to emit laser light. L in an emission direction DE orthogonal to the X-axis, for example. The laser light L is visible light, for example. The laser light L may be infrared light, ultraviolet light, or an X-ray.

The collimator lens 23 is spaced apart from the laser oscillator 22 in the emission direction DE. The collimator lens 23 converts the laser light L incident from the laser oscillator 22 to parallel light, and emits the resultant to the scan device 25. In other words, the collimator lens 23 converts passing light to light having an infinite focal distance.

The cylindrical lens 24 is located between the collimator lens 23 and the scan device 25. The cylindrical lens 24 has a columnar shape extending in the X-direction. Thus, the generating line of the cylindrical lens 24 extends in the X-direction. The generating line refers to a plurality of straight lines defining the curved surface of the cylindrical lens 24 and extending in parallel.

The cylindrical lens 24 converts the laser light L having passed through the collimator lens 23 to strip-form light (sheet light) orthogonal to the X-direction, and emits the resultant to the scan device 25. In this embodiment the term “orthogonal” includes slightly tilted crossing in addition to completely orthogonal crossing

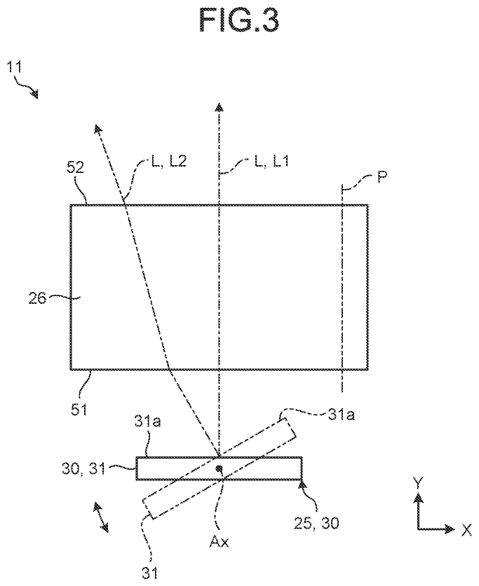

FIG. 3 is an exemplary plan view schematically illustrating a part of the illumination system 11 of the first embodiment. As illustrated in FIG. 3, the scan device 25 includes a MEMS mirror 30. The MEMS mirror 30 is an example of a MEMS.

The MEMS mirror 30 is micro electro mechanical systems (MEMS) including various components and circuits on a substrate. Note that the scan device 25 is not limited to the MEMS. As illustrated in FIG. 2, the MEMS mirror 30 includes a mirror 31 and a rotation device 32.

The mirror 31 has a reflective surface 31a. The reflective surface 31a is a substantially flat surface by which the laser light L is reflected. The reflective surface 31a of this embodiment reflects visible light. The reflective surface 31a reflects the laser light which can be infrared light, ultraviolet light, or X-ray.

The rotation device 32 rotates the mirror 31 around a rotation axis Ax to rotate the reflective surface 31a around the rotation axis Ax. The rotation axis Ax is a virtual axis of the rotation of the reflective surface 31a.

In this embodiment, the direction in which the rotation axis Ax extends is orthogonal to the generating line of the cylindrical lens 24. In other words, the rotation axis Ax extends in a direction orthogonal to the X-direction in which the generating line of the cylindrical lens 24 extends. The rotation axis Ax thus extends in parallel with. the strip-form laser light L emitted from the cylindrical lens 24. Further, in this embodiment, the extending direction of the rotation axis Ax is inclined relative to the emission direction DE by approximately 67.5°. Note that the rotation axis Ax is not limited to such an example.

The rotation device 32 includes, for example, a support shaft 41, a coil 42, and a magnet 43. The support shaft 41 extends along the rotation axis Ax to support the mirror 31. The coil 42 is disposed in the mirror 31. The magnet 43 generates a magnetic field passing through the coil 42. The rotation device 32 supplies a current to the coil 42 to apply the Lorentz force to the mirror 31 around the rotation axis Ax. The rotation device 32 thereby rotates the mirror 31 around the rotation axis Ax. Note that the rotation device 32 is not limited to such an example, and a motor or a piezoelectric element may be used to rotate the mirror 31 around the rotation axis Ax, for example.

The prism. 26 is, for example, a substantially triangular optical prism extending in the X-direction. The prism 26 may have another shape. For example, the prism 26 may have a columnar shape having a substantially trapezoidal cross-section without a part of the triangular prism.

The prism 26 has a first surface 51 and a second surface 52. The first surface 51 and the second surface 52 are side surfaces of the substantially triangular prism. Thus, a direction orthogonal to the first surface 51 and a direction orthogonal to the second surface 52 cross each other. In this embodiment, the angle (apical angle)) θ between the first surface 51 and the second surface 52 is set at, for example, 20±10°, although the angle θ is not limited to such an example.

The first surface 51 and the second surface 52 are flat surfaces orthogonal to the same virtual plane P. The virtual plane P is orthogonal to the X-axis. In short, the first surface 51 and the second surface 52 extend in the X-direction. The first surface 51 and the second surface 52 may be shorter in length in the X-direction than in the other directions.

The rotation axis Ax of the scan device 25 extends in a direction parallel to the virtual plane P. The first surface 51 and the second surface 52 extend in parallel with the generating line of the cylindrical lens 24. Thus, the strip-form laser light L emitted from the cylindrical lens 24 is also parallel to the virtual plane P. In this embodiment the term “parallel” is not limited to complete parallel.

The prism 26 in this embodiment is located between the cylindrical lens 24 and the scan device 25 and between the scan device 25 and the exit window 21b of the casing 21. The first surface 51 faces the scan device 25. The second surface 52 faces the cylindrical lens 24 and the exit window 21b.

The laser light L passes through the collimator lens 23 and the cylindrical lens 24 and is incident on the second surface 52 of the prism 26. The prism 26 emits the incident laser light L from the first surface 51 to the reflective surface 31a of the scan device 25. The prism 26 refracts the laser light L by the second surface 52 and the first surface 51. However, the prism 26 may not refract the laser light L vertically incident on the first surface 51 or the second surface 52.

The reflective surface 31a of the scan device 25 reflects the laser light L having passed through the collimator lens 23, the cylindrical lens 24, and the prism 26 to the first surface 51 of the prism 26. Since the rotation. axis Ax is inclined relative to the emission direction DE by approximately 67.5°, the normal of the reflective surface 31a is inclined relative to the emission direction. DE by approximately 22.5′. The reflective surface 31a thus reflects the laser light L in a direction inclined by approximately 45° relative to the emission direction. DE. Note that the angle of reflection at which the laser light. L is reflected by the reflective surface 31a is not limited to such an example.

The laser light L reflected by the reflective surface 31a enters the first surface 51 of the prism 26. The prism 26 emits the laser light L from the second surface 52 toward the exit window 21b. The prism 26 refracts the laser light L by the first surface 51 and the second surface 52.

The laser light L emitted from the second surface 52 exits from the exit window 21b to outside the LIDAR system 10. The laser light L illuminates, for example, an object to be measured and is reflected by the object.

As illustrated in FIG. 1, the light-receiving system 12 is, for example, adjacent to the illumination system 11 in the X-direction, although the light-receiving system 12 may be spaced apart from the illumination system 11 in addition to this example. The light-receiving system 12 includes a casing 61, an imaging lens 62, and an optical sensor 63. The light-receiving system 12 is not limited to such an example and may additionally include other parts or components, for example.

The casing 61 accommodates the imaging lens 62 and the optical sensor 63 in its internal space 61a. The casing 61 has an entrance window 61b. The entrance window 61b is a member that covers the internal space 61a and allows light to pass through. Note that the entrance window 61b is not limited to such an example and may be a hole that opens the internal space 61a to outside. The entrance window 61b faces, for example, the Y-direction. The casing 61 is united, for example, with the casing 21 of the illumination system 11.

The imaging lens 62 gathers the laser light L having been reflected by the object to be measured and having passed through the entrance window 61b. The imaging lens 62 gathers the laser light L so that the laser light L focuses on photo-sensitive elements of the optical sensor 63, for example.

The optical sensor 63 includes a plurality of photo-sensitive elements arranged in the X-direction and the Z-direction. The photo-sensitive elements are, for example, photodiodes. In short, the plurality of photo-sensitive elements is arranged in a rectangular lattice. Note that the arrangement of the photo-sensitive elements is not limited to this example. The optical sensor 63 generates an electrical signal on the basis of the light incident on the photo-sensitive elements.

The control device 13 is exemplified by a computer including a processor such as a central processing unit (CPU), a storage device such as a read-only memory (ROM), a random-access memory (RAM), and a flash memory, and a bus connecting them with one another. The control device 13 is electrically connected to the illumination system 11 and the light-receiving system 12.

The processor of the control device 13 reads and executes a program from the ROM or the flash memory to control the illumination system 11 and the light-receiving system. 12. For example, the control device 13 controls the laser oscillator 22 to perform pulsed operation to emit the laser light L. The control device 13 causes the rotation device 32 to rotate the mirror 31 by applying a current to the coil 42 The control device 13 acquires the electrical signal generated by the optical sensor 63.

The control device 13 calculates the shape of the object and the distance to the object, for example, from a difference between time at which the laser oscillator 22 has emitted the laser light L and time at which the optical sensor 63 has received the laser light L reflected by the object. The control device 13 is not limited to such an example.

Hereinafter, for the sake of convenience, the orientation or angle of the reflective surface 31a reflecting the strip-form laser light orthogonally to the first. surface 51 of the prism 26 is defined as 0°, as indicated by the solid line of FIG. 3. In other words, the orientation of the reflective surface 31a reflecting the strip-form laser light L in parallel with the virtual plane P is defined as 0°.

The rotation device 32 rotates the mirror 31 around the rotation axis Ax in a clockwise or counterclockwise direction in FIG. 3. FIG. 3 illustrates, by a dashed-and-double-dotted line, the mirror 31 rotated by a given angle around the rotation axis Ax.

Hereinafter, the laser light L reflected by the reflective surface 31a of the mirror 31 at the angle 0° is referred to as laser light L1. In FIG. 2, the laser light L1 is indicated by a dashed-and-dotted line. The laser light reflected by the reflective surface 31a of the mirror 31 rotated by some non-zero angle is referred to as laser light L2. In. FIG. 2, the laser light L2 is indicated by a dashed-and-double-dotted line. The explanation of the laser light L be considered as the common explanation of the laser light L1 and L2.

The LIDAR system 10 measures the shape of the object and the distance to the object, for example, as described below, although it is not intended to limit the measurement by the LIDAR system 10.

First, as illustrated in FIG. 2, the control device 13 causes the laser oscillator 22 to perform pulsed operation to emit the laser light L. The laser light L is converted to parallel light through the collimator lens 23.

Having passed through the collimator lens 23, the laser light L passes through the cylindrical lens 24 and is thereby converted to strip-form light orthogonal to the X-direction. The strip-form laser light L diverges after converging, for example. The strip-form laser light L may diverge without converging.

Having passed through the cylindrical lens 24, the laser light L passes through the prism 26, entering the second surface 52 of the prism 26 and exiting from the first surface 51. The laser light L is reflected at the time of entering the second surface 52 and exiting from the first surface 51.

The strip-form laser light t is orthogonal to the first surface 51 and the second surface 52. Thus, the strip-form laser light L is reflected in a Y-Z plane orthogonal to the X-direction (in FIG. 2) while the strip-form user light L exhibits substantially no reflection in an X-Y plane (in FTG. 3), for example. The laser light L may be reflected in the X-Y plane.

Having passed through the prism 26, the laser light L is reflected by the reflective surface 31a of the scan device 25. The laser light L reflected by the reflective surface 31a enters the first surface 51 of the prism 26 and exits from the second surface 52 of the prism 26. The laser light L is reflected when entering the first surface 51 and exiting from the second surface 52.

As illustrated in FIG. 3, the laser light L1 reflected by the reflective surface 31a of the mirror 31 at the angle 0° is orthogonal to the first surface 51 and the second surface 52. Thus, the strip-form laser light L1 is reflected in the Y-Z plane orthogonal to the direct on as illustrated in. FIG. 2 while the strip-form laser light L1 exhibits substantially no reflection in the X-Y plane as illustrated in FIG. 3. However, the laser light L1 may be reflected in the X-direction.

Meanwhile, the laser light 12 reflected by the reflective surface 31a of the mirror 31 rotated by a given angle diagonally crosses the first surface 51 and the second surface 52. Thus, the strip-form laser light L2 is reflected in both of the Y-Z plane and the X-Y plane.

The laser light L having passed through the prism 26 is incident on the reflective surface 31a at different angles (angle of incidence) depending on the orientation of the reflective surface 31a. That is, as illustrated in FIG. 2, the angle at which the laser light L1 is reflected by the reflective surface 31a (angle of reflection) and the angle at which the laser light 12 is reflected by the reflective surface 31a (angle of reflection) are different from each other.

Due to the difference in angle of reflection, the incidence angle of the laser light L1 on The first surface 51 and the second surface 52 is different from the incidence angle of the laser light L2 on the first surface 51 and the second surface 52. Thus, the laser light Li and The laser light L2 are reflected by the prism 26 in different manners.

Having passed through the prism 26, the laser light L exits from the exit window 21b of the casing 21 to outside the LIDAR system 10. The strip-form laser light L extends in approximately the Z-direction (substantially vertical direction). The rotation device 32 rotates the reflective surface 31a around the rotation axis Ax, causing the strip-form laser light L extending in the Z-direction to travel in approximately the X-direction. Thereby, the object is scanned in approximately the X-direction with the laser light L that is collectively focused on in a given range in the Z-direction.

As described above, the LIDAR system 10 is capable of scanning a given range of the X-Z plane with the laser light L. Hereinafter, the scanning range of the laser light L on the X-Z plane is referred to as an illumination field AL of the laser light L. Further, the X-direction is referred to as a main-scanning direction, and the Z-direction is referred to as a sub scanning direction.

As illustrated in. FIG. 1, the imaging lens 62 functions to allow the laser light L reflected by the object to gather on the optical sensor 63. The optical sensor 63 receives the laser light L and generates an electrical signal on the basis of the laser light L.

Then, the control device 13 acquires the electrical signal generated by the optical sensor 63. In accordance with the electrical signal, the control device 13 calculates the shape of the object and the distance to the object from a difference between time at which the laser oscillator 22 has emitted the laser light L and time at which the optical sensor 63 has received the laser light L reflected by the object.

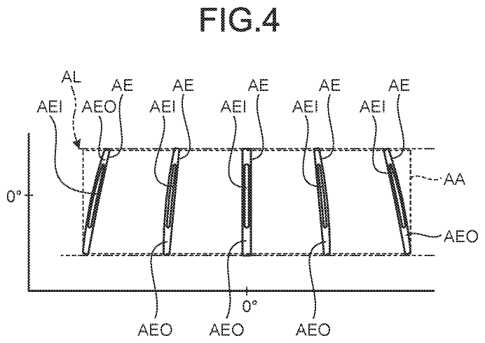

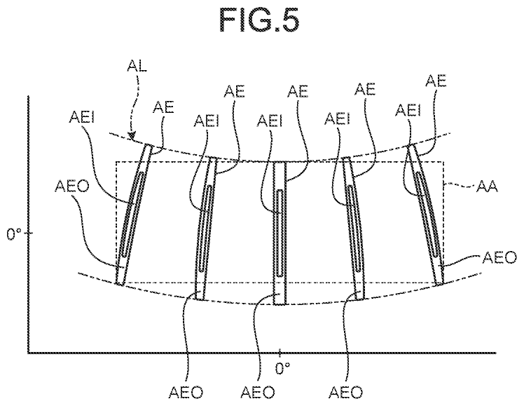

FIG. 4 is an exemplary graph schematically illustrating light distribution of the laser light L of the first embodiment. FIG. 5 is an exemplary graph schematically illustrating light distribution of the laser light L for comparison. FIG. 5 illustrates a comparative example of the light distribution of the laser light L emitted from the LIDAR system 10 without the prism 26.

Horizontal axes in FIGS. 4 and 5 represent the orientation of the reflective surface 31a around the rotation axis Ax. Further, the horizontal axes in FIGS. 4 and 5 correspond to the coordinates of the illumination field AL in the X-direction. Vertical axes in FIGS. 4 and 5 represent the angle at which the strip-form laser light L diverges (angle of divergence). Further, the vertical axes in FIGS. 4 and 5 correspond to the coordinates of the illumination field AL in the Z-direction.

FIGS. 4 and 5 illustrate regions AE irradiated with the laser light L when the reflective surface 31a is oriented at five predetermined angles. In each of the regions AE, an inner region. AEI is a region having a relatively high luminous intensity, and an outer region AEO is a region having a relatively low luminous intensity.

The reflective surface 31a is diagonally inclined. relative to the direction of incidence of the laser light L on the reflective surface 31a. Thus, as illustrated in FIG. 5, without the prism 26, the region AE irradiated with the laser light L reflected by the reflective surface 31a changes in position in the Z-direction (sub-scanning direction) in accordance with the rotation of the reflective surface 31a. The displacement of the region AE in the sub-scanning direction causes the illumination field AL of the laser light L to be distorted, for example, in a substantially U-shape.

As described above, the photo-sensitive elements of the optical sensor 63 are arranged in a rectangular lattice. Thus, the illumination field AA that the optical sensor 63 can sense has a substantially rectangular shape, as indicated by broken lines in FIGS. 4 and 5. The illumination field AL and the illumination field AA are set such that the illumination field AA is included in the illumination field AL of the laser light L.

As illustrated in FIG. 5, without the prism 26. The illumination field AL of the laser light L is distorted, which results in an increase in the difference in shape between the illumination field AL and the illumination field AA. In such a case, in order to allow the illumination field AA to be included in the illumination field AL, the laser light L is generally diverged largely in the sub-scanning direction. This, however, increases unused part of the illumination field AL outside the illumination field AA. Further, the laser light L is decreased in illuminance due to the divergence, which may result in shortening the distance at which the LIDAR system 10 can measure the object.

Meanwhile, the laser light L1 and the laser light L2 are reflected by the prism 26 in different manners, as described above. The prism 26 refracts the laser light L (laser light L1, L2) in such a manner to reduce the displacement of the region AB in the sub-scanning direction along with the rotation of the reflective surface 31a.

The prism 26 refracts the laser light L as described above, so that the illumination field AL of the laser light L is less distorted and the shape of the illumination field AL becomes similar to the shape of the illumination field AA, as illustrated in FIG. 4. This can decrease the unused part of the illumination field AL, making it possible to set the laser light L at a smaller divergence in the sub-scanning direction. Because of this, the laser light L is prevented from lowering in illuminance so that the LIDAR system 10 can elongate its measurable range.

In the LIDAR system 10 according to the first embodiment described above, the scan device 25 includes he reflective surface 31a by which the laser light L is reflected and the rotation device 32 that rotates the reflective surface 31a around the rotation axis Ax. The scan device 25 scans the surface of the object with the laser light L reflected by the reflective surface 31a in the X-direction (main-scanning direction) substantially orthogonal to the rotation axis Ax, by rotating the reflective surface 31a around the rotation axis Ax. Generally, in the LIDAR system. 10, the reflective surface 31a is inclined diagonally relative to the direction of incidence of the laser light L on the reflective surface 31a. This may cause displacement of the region AE irradiated with the laser light L reflected by the reflective surface 31a in the Z-direction (sub-scanning direction) orthogonal to the main-scanning direction, along with the rotation of the reflective surface 31a. The displacement of the region AE in the sub-scanning direction causes the illumination field AL scanned by the laser light L to be distorted. The illumination field AA that the optical sensor 63 can sense has a rectangular shape, so that the LIDAR system 10 diverges the laser light L in such a manner that the distorted illumination field AL becomes larger than the rectangular illumination field AA. It is however difficult for the diverged laser light L to reach far, which may shorten the measurable range of the LIDAR system 10. To the contrary, in this embodiment, the prism 26 has the first surface 51 and the second surface 52, and the laser light L reflected by the reflective surface 31a enters the first surface 51 and exits from the second surface 52. Thus, the prism 26 functions to retract the laser light L reflected by the reflective surface 31a. For example, the laser light L with a relatively small displacement and the laser light L with a relatively large displacement in the sub-scanning direction are different in angle of incidence on the prism 26. In addition, the difference between the angle of incidence and the angle of refraction of the laser light L on The prism 26 depends on the angle of incidence of the laser light L on the prism 26. In view of this, the prism 26 refracts the laser light L in such a manner to reduce the displacement of the region AE in the sub-scanning direction. Because of such optical characteristics of the prism 26, for example, the LIDAR system 10 of this embodiment can reduce the displacement of the region AE in the sub-scanning direction and reduce the distortion of the illumination field AL. Thus, without diverging the laser light L beyond the illumination field AA of the optical sensor 63, the LIDAR. system 10 can improve its measurable range.

The first surface 51 and the second surface 52 are orthogonal to the same virtual plane P. The direction orthogonal to the first surface 51 crosses the direct on. orthogonal to the second surface 52. In other words, the prism 26 has a rectangular columnar shape extending in a longitudinal direction orthogonal to the virtual plane P. It is thus made possible to simplify, for example, calculation of the reflection of the laser light L through the prism 26, resulting in facilitating adjustment of the illumination field AL.

The rotation axis Ax of the rotation device 32 extends in a direction parallel to the virtual plane P. This leads to simplifying, for example, the relationship between the orientation of the reflective surface 31a and the angle of incidence of the laser light L on the prism 26, resulting in facilitating adjustment of the illumination field AL.

The cylindrical lens 24 is located between the collimator lens 23 and the scan device 25. The generating line of the cylindrical lens 24 is orthogonal to the direction in which the rotation axis Ax extends. Thereby, the laser light L is converted through the cylindrical lens 24 into strip-form light (sheet light) along the rotation axis Ax. The sheet light is longer in the sub-scanning direction. Thus, the LIDAR system 10 of this embodiment can irradiate the illumination field AL extending in the main-scanning direction and the sub-scanning direction with the laser light L by scanning the laser light L in the main-scanning direction. Further, the LIDAR system 10 can exclude a rotation device that rotates the reflective surface 31a around two rotation axes. Generally, the size of the reflective surface 31a of the scan device 25 such as a MEMS mirror is inversely proportional to the number of rotation axes. Thus, in the LIDAR system 10 of this embodiment, the size of the reflective surface 31a can be increased. In. addition, the area of the reflective surface 31a which the laser light L enters changes less relative to the change in orientation of the reflective surface 31a. Thus, the LIDAR system 10 of this embodiment can be prevented from lowering in the use efficiency of the laser light L.

The first surface 51 and the second surface 52 extend in parallel with the generating line of the cylindrical lens 24. This makes the shape of the illumination field AL be substantially mirror symmetric, for example, facilitating adjustment of the illumination field AL.

The prism 26 allows the laser light L having passed. through the collimator lens 23 to enter the second surface 52 and exit from the first surface 51 to the reflective surface 31a. In other words, the laser light L is reflected by the prism 26 before entering the reflective surface 31a. Thereby, the prism 26 decreases the divergence of the laser light L to enter the reflective surface 31a, reducing the area of the first surface 51 on which the laser light L is incident. This can lead to down sizing the prism 26.

The scan device 25 includes the MEMS mirror 30 including the reflective surface 31a and The rotation device 32. Thereby, the LIDAR system 10 of this embodiment can be downsized.

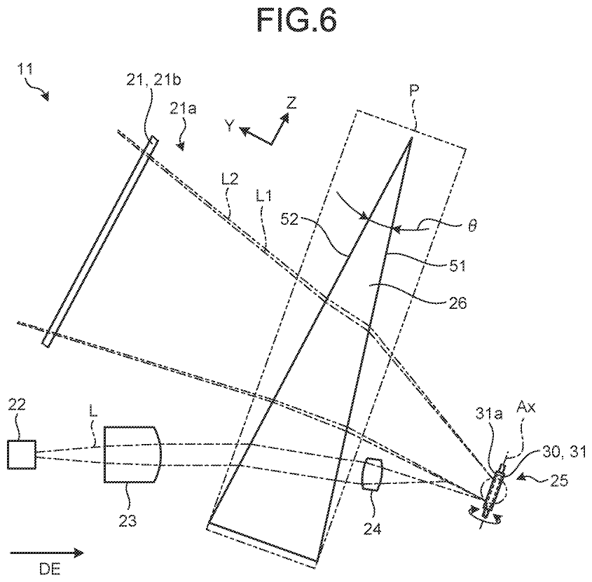

FIG. 6 is an exemplary side view schematically illustrating the illumination system 11 according to a modification of the first embodiment. In the example of FIG. 2, the cylindrical lens 24 is located between the collimator lens 23 and the prism 26. However, in the modification of FIG. 6, the cylindrical lens 24 is located between the prism 26 and the reflective surface 31a of the scan device 25. In the modification of FIG. 6, the cylindrical lens 24 is also located between the collimator lens 23 and the scan device 25.

In this modification, having passed through the collimator lens 23, the laser light L passes through the prism 26, entering the second surface 52 of the prism 26 and exiting from the first surface 51 toward the cylindrical lens 24. The laser light L is reflected at the time of entering the second surface 52 and exiting from the first surface 51. The laser light L remains as parallel light while passing the first surface 51 and the second surface 52. The laser light L exiting from the first surface 51 is thus parallel light.

The laser light having exited from the first. surface 51 is converted through the cylindrical lens 24 into strip-form light orthogonal to the X-direction. The strip-form laser light L diverges and is reflected by the reflective surface 31a of the scan device 25.

In the LIDAR system 10 of the modification described above, the laser light L as the parallel light passes through the prism 26 before it is diverged by the cylindrical lens 24. As a result, decrease in the angle of divergence of the laser light L due to the prism 26 can be prevented.

### Second Embodiment

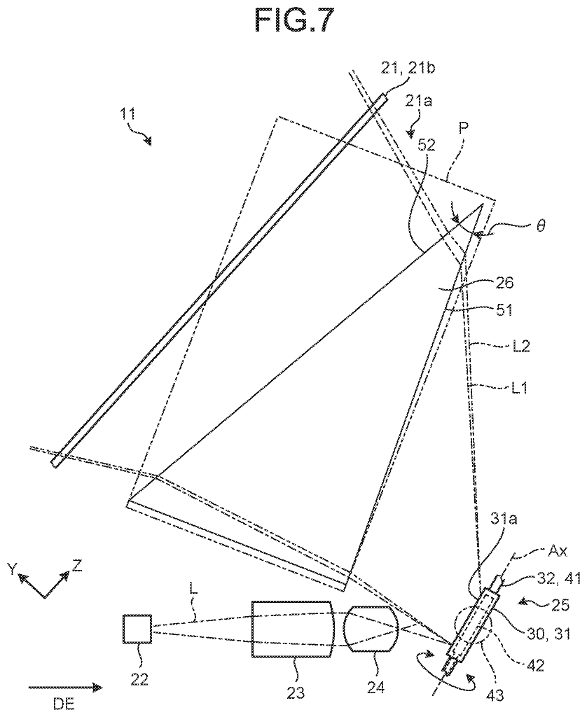

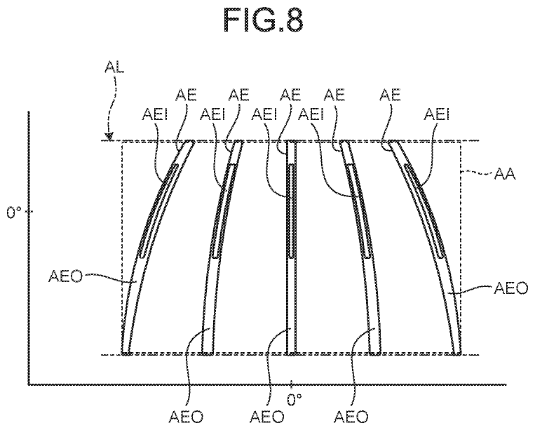

Descriptions of a second embodiment are provided below with reference to FIGS. 7 and 8. Note that, in the following description of the embodiment, a constituent element with a function similar to that of the constituent element described above is given the same reference sign as that of the constituent element described above, and further, description thereof is omitted in some cases. Further, a plurality of constituent elements given the same reference sign may not necessarily have all functions and properties in cannon, but may have different functions and properties according to each embodiment.

FIG. 7 is an exemplary side view schematically illustrating an illumination system 11 according to the second embodiment. As illustrated in FIG. 7, the prism 26 of the second embodiment is located neither between the collimator lens 23 and the cylindrical lens 24 nor between the cylindrical lens 24 and the scan device 25. In other words, the prism 26 is spaced apart from a path (optical path) of the laser light L between the, collimator lens 23 and the scan device 25.

In the second embodiment, the angle (apical angle) θ between the first surface 51 and the second surface 52 is set at, for example, 30±10°, although the angle θ is not limited to such an example.

In the second embodiment, the laser light L having passed through the collimator lens 23 is converted through the cylindrical lens 24 into strip-form light orthogonal to the X-direction. The strip-form laser light L having passed through the cylindrical lens 24 is reflected by the reflective surface 31a of the scan device 25.

Having been reflected by the reflective surface 31a, the laser light L, passes through the prism 26, entering the first surface 51 of the prism 26 and exiting from the second surface 52. The laser light L is reflected at the time of entering the first surface 51 and exiting from the second surface 52.

In the second embodiment, the laser light L diverges through the cylindrical lens 24 and is reflected by the reflective surface 31a without being reflected by the prism 26. This arrangement can prevent a decrease in the angle of divergence of the laser light L due to the prism 26.

FIG. 8 is an exemplary graph schematically illustrating light distribution of the laser light L, of the second embodiment. As illustrated in FIG. 8, the prism 26 causes no decrease in the angle of divergence of the laser light L between the collimator lens 23 and the scan device 25, therefore, the laser light L irradiates the region AE of an extended length in the sub-scanning direction. In other words, the illumination field. AL of the laser light L is increased in the sub-scanning direction. Thereby, the LIDAR system 10 can adopt, for example, the optical sensor 63 having a larger illumination field AA and facilitate measurement of an object in a relatively short range.

In the LIDAR system 10 of the second embodiment described above, the prism 26 is spaced apart from the path (optical path) of the laser light L between the collimator lens 23 and the scan device 25. This arrangement can prevent a decrease in the angle of divergence of the laser light L passing through the cylindrical lens 24, which would otherwise occur due to the prism 26.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A LIDAR system comprising:
a laser oscillator that emits laser light;
a collimator lens that converts the laser light to parallel light;
a scan device comprising a reflective surface by which the laser light having passed through the collimator lens is reflected, and a rotation device that rotates the reflective surface around a rotation axis; and
a prism having a first surface and a second surface, the prism that allows the laser light reflected by the reflective surface to enter the first surface and exit from the second surface.

2. The LIDAR system according to claim 1, wherein the first surface and the second surface are orthogonal to a same virtual plane, and
a direction orthogonal to the first surface crosses a direction orthogonal to the second surface.

3. The LIDAR system according to claim 2, wherein the rotation axis extends in a direction parallel to the virtual plane.

4. The LIDAR system according to claim 1, further comprising
a cylindrical lens that is located between the collimator lens and the scan device and has a generating line orthogonal to an extending direction of the rotation axis.

4. The LIDAR system according to claim 4, wherein the first surface and the second surface extend in parallel with the generating line of the cylindrical lens.

6. The LIDAR system according to claim 1, wherein
the prism allows the laser light having passed through the collimator lens to enter the second surface and exit from. the first surface to the reflective surface.

7. The LIDAR system according to claim 1, wherein
the scan device comprises micro electro mechanical systems (MEMS) including the reflective surface and the rotation device.
